(19) United States
(12) Patent Application Publication
(10) Pub. No.: US 2008/0063144 A1
(43) Pub. Date: Mar. 13, 2008

(54) METHOD AND SYSTEM FOR SIMULTANEOUSLY ILLUSTRATING MULTIPLE VISUAL DISPLAYS

(75) Inventor: Barry F. Belanger, Chenequa, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/470,696

(22) Filed: Sep. 7, 2006

(51) Int. Cl. H05G 1/70

(52) U.S. Cl. 378/92; 378/98

(57) ABSTRACT

A system for arranging a plurality of visual displays communicated from a plurality of data acquiring sources for illustration on a plurality of displays fields of an at least one monitor is provided. The system includes a controller in communication with each of the plurality of data acquiring sources and the at least one monitor. The controller includes a processor operable to execute a plurality of programming instructions stored in a memory. The programming instructions include the acts of receiving a predefined arrangement of the series of visual displays for simultaneous illustration in the series of display fields of the at least one monitor, storing the predefined arrangement in the memory, and communicating the plurality of visuals displays from the series of data acquiring sources to the series of display fields, respectively, of the least one monitor in accordance to the predefined arrangement stored in the memory.

### BACKGROUND OF THE INVENTION

This invention generally relates to a method of and system for medical diagnostic imaging, and more particularly to a system and method of illustrating multiple graphic displays.

Medical procedures (e.g., angioplasty, ablations for atrial fibrillation, etc.) typically involve simultaneous use of many pieces of medical equipment in a crowded environment. Many of these devices include a dedicated monitor for displaying some combination of alphanumeric, physiological, anatomical image and functional image data associated with the respective medical equipment. The multiple dedicated monitors are typically arranged in a cluster array; while others may be brought in on a cart when needed with the respective medical equipment to perform the medical procedure.

A drawback of conventional medical equipment and the above-described carts is that the multiple display monitors takes up valuable space in a crowded environment. The emergence of new medical procedures that combine two or more conventional medical procedures further exacerbates the drawback of multiple dedicated monitors. The cluster of display monitors is also not ready interchangeable into other arrangements as desired by different clinicians and/or for different procedures.

Hence there exists a need to provide a method of and system for illustrating graphic images that is readily interchangeable for a respective clinician or medical procedure. Also, the system should reduce the number of monitors needed, and thereby reduce the space occupied by suspended and cart-mounted monitors.

### BRIEF DESCRIPTION OF THE INVENTION

The above-mentioned shortcomings, disadvantages and problems are addressed by the embodiments described herein in the following description of a method and system of arranging multiple graphic images received from multiple image acquiring sources.

In one embodiment, a system for arranging a plurality of visual displays communicated from a plurality of data acquiring sources for illustration on a plurality of displays fields of at least one monitor is provided. The system includes a controller in communication with each of the plurality of data acquiring sources and the at least one monitor. The controller includes a processor operable to execute a plurality of programming instructions stored in a memory. The programming instructions include the acts of receiving at least one predefined arrangement of the series of visual displays for simultaneous illustration in the series of display fields of the at least one monitor, storing the at least one predefined arrangement in the memory, and communicating the plurality of visuals displays from the series of data acquiring sources to the series of display fields, respectively, of the at least one monitor for illustration in accordance to one of the at least one predefined arrangements stored in the memory.

In another embodiment, a method of communicating a plurality of visual displays for simultaneous viewing on at least one monitor is provided. Each visual display is received from one of a series of data acquiring sources. The method comprises the acts of receiving a predefined arrangement of the serine of visual displays for simultaneous illustration in the series of display fields of the at least one monitor; storing the arrangement in the memory; and communicating the series of visuals displays from the series of data acquiring sources to the series of display fields, respectively, of least one monitor for illustration in accordance to the predefined arrangement stored in the memory.

An embodiment of a system for simultaneously illustrating a series of visual displays received from a series of data acquiring sources is also provided. The system comprises at least one monitor that includes a series of display fields, an input device, and a controller connected in communication with the at least one monitor, each of the series of data acquiring sources and the input device. The controller includes a processor operable to execute a series of programming instructions stored in a memory. The programming instructions include acts of receiving and storing one of a series of arrangements of the series of visual displays for viewing on the monitor; receiving the series of the acquired visual displays from the series of data acquiring sources; automatically selecting one of the series of arrangements based on an input data received via the input device; and displaying each of the series of graphic images from the series of data acquiring sources in a respective one of the series of display fields for simultaneous viewing on the at least one monitor in accordance to the act of automatically selecting one of the series of arrangements.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an embodiment of a system for arranging a series of visual displays received from a series of data acquiring sources, respectively.

FIG. 2 shows a schematic diagram of an embodiment of a single monitor that comprises a series of display fields for simultaneous illustration of a series of visual displays received from a series of data acquiring sources.

FIG. 3 illustrates a schematic diagram of an embodiment of a theater that includes a system operable to illustrate a preprogrammed arrangement of visual displays received from a series of data acquiring sources associated with a medical procedure.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

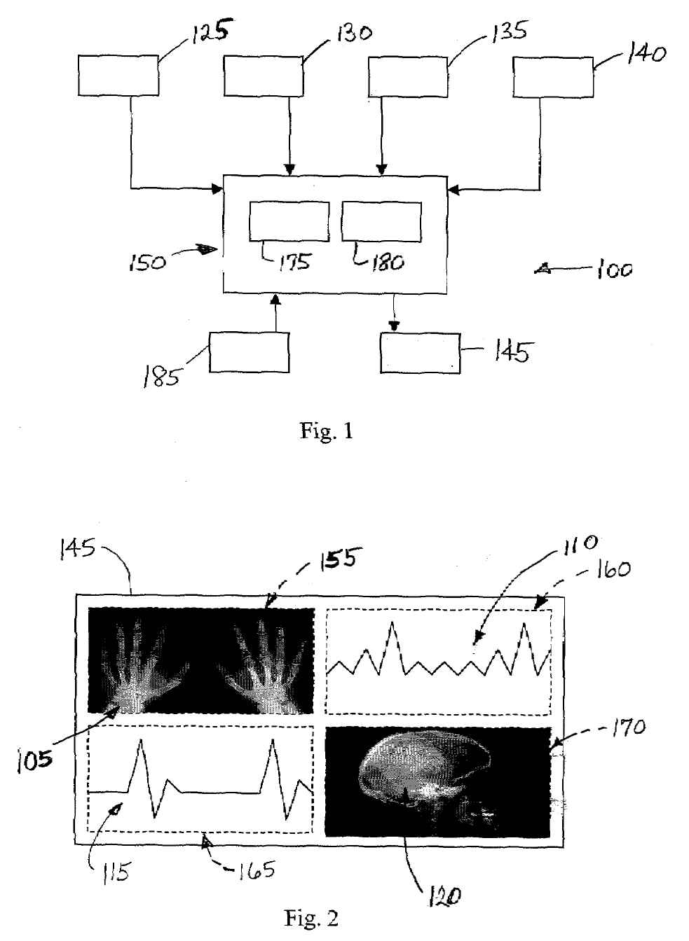

FIG. 1 illustrates an embodiment of a mapping system 100 having a technical effect of providing for pre-programming a map or arrangement of multiple visual displays 105, 110, 115 and 120 (See FIG. 2) generated by at least one of a series of data sources 125, 130, 135, and 140, respectively, for simultaneous illustration during a step of a medical procedure.

Each of the series of data sources 125, 130, 135, and 140 can include, but is not limited to, a Computed Tomography (CT) imaging system, a magnetic resonance imaging (MRI) imaging system, a electrocardiogram (ECG) system, a Positron Emission Transmission/Computed Tomography (PET/CT) imaging system, an ultrasound imaging systems, a real-time fluoroscopic imaging system, an endoscopic imaging system, etc. Each of the series of data sources 125, 130, 135, and 140 is operable to generate a signal representative of one of the visual displays 105, 110, 115 and 120 (See FIG. 2) for viewing by the clinician. The series of data sources 125, 130, 135, and 140 can also include a workstation operable to receive and/or store one or more visual displays 105, 110, 115, and 120 pre-recorded by one or more of the other data sources 125, 130, and 140 and stored for later access by the system 100. The series of data sources 125, 130, 135, and 140 can be connected to communicate the signal representative of the visual displays 125, 130, 135, and 140 directly or indirectly to the mapping system 100.

Referring now to FIG. 2, the visual displays 105, 110, 115 and 120 can include, but is not limited to, a representation of a physiological waveform, an anatomical image, physiological functional image (e.g., ultrasound images, transesophagial ultrasound acquired image, transthoracic ultrasound acquired image, intravascular ultrasound (IVUS) acquired image, alphanumeric data or messages representative of measured data, a software interface or window, and other conventional medical acquired data, and/or combinations thereof) communicated by the series of data acquiring sources 125, 130, 135, and 140 (See FIG. 1) in a continuous, periodic, or selected manner. One or more of the visual displays 105, 110, 115, and 120 can be acquired real-time or pre-recorded and stored for later access by the mapping system 100 (See FIG. 1).

As shown in FIG. 1, the mapping system 100 generally includes at least one monitor 145, and a controller 150 connected in communication with the monitor 145 and each of the plurality of data acquiring sources 125, 130, 135, and 140. Referring now to FIG. 2, the at least one monitor 145 is generally operable to support at least one active display field 155, 160, 165, and 170 capable of illustrating at least one of the visual displays 105, 110, 115 and 120 for viewing. The at least one display field 155, 160, 165 and 170 are comprised of pixels or other known medium that together with others are capable of constituting a visual representation of an electrical signal. The illustrated embodiment of the at least one monitor 145 is a liquid crystal display (LCD) monitor operable to simultaneously support four different, independent, active display fields 155, 160, 165, and 170. An embodiment of the four different, independent, active display fields 155, 160, 165, and 170 includes an upper right display field 155, an upper left display field 160, a lower right display field 165, and a lower left display field 170. Yet, it should be understood that the number of display fields can vary. Also, the size and type (e.g., flat-screen, projection, plasma, LCD, conventional tube, black-and-white, color, etc. or combinations thereof) of the at least one monitor 145 can vary. The at least one monitor 145 can be located on a cart, a wall, a ceiling, etc. or combinations thereof.

Referring to FIGS. 1 and 2, the number of monitors 145 of the mapping system 100 can vary in accordance to the varying types of visual displays 105, 110, 115, and 120 (see FIG. 2) for illustration. For example, one or more visual displays 105, 110, 115, and 120 may be of a type (e.g., X-ray images, etc.) that is be better illustrated on a black-and-white monitor, while other visual displays may be of a type (e.g., CT scan images, MRI scan images, PET/CT scan images, etc.) better illustrated on a color monitor. Also, one or more of the visual displays 105, 110, 115, and 120 may be better illustrated on a monitor 145 having a very high refresh rate. Accordingly, the number of monitors 145 can depend on the variety of visual displays 105, 110, 115 and 120.

Referring again to FIG. 1, the controller 150 generally includes a processor 175 in communication with and operable to execute a series of programming instructions or software stored in a memory 180. One embodiment of the controller 150 is located as part of one of the data acquiring sources 125, 130, 135, and 140. Another embodiment of the controller 150 includes a stand-alone computer (e.g., desktop or laptop, blackberry, etc.). Yet, the controller 150 can include various arrangements or combinations of various types of processors (e.g., microprocessor, programmable logic controller, etc.) 175 with various types of memory (e.g., memory stick, hard-drive, disk, CD, DVD, or other conventional storage medium) 180. The controller 150 can also be connected in communication with an input device 185 such as a keyboard, a touch-screen, a keypad, a joystick, dials, or other conventional input device or combination thereof operable to receive data from the user or clinician.

Having described a general construction of the embodiment of the mapping systems 100, the following is a general description of the operation and technical effect of an embodiment of the mapping system 100 connected in combination with the, series of data acquiring sources 125, 130, 135, and 140 and at least one monitor 145 described above. Although the operation is described in accordance to the following acts, it should be understood that the sequence of the acts can vary. Also, it should be understood that the following description of acts is not limiting, and that one or more of the described acts may not be needed.

Assume initially that each of the multiple image acquiring sources 125, 130, 135, and 140 is not connected in communication with the controller 150. The user or clinician is operable to program the controller 150 via the input 185 with multiple preprogrammed maps or arrangements of visual displays for illustration in the series of display fields 155, 160, 165, and 170 of the at least one monitor 145 in accordance to at least a step of a medical procedure. Each of the predetermined arrangements of visual displays is stored in the memory 180 with an identifier either assigned by the user and/or the controller 150 for access by the processor 175. In one example, one or more of the multiple pre-programmed arrangements of visual displays is stored with an identifier of a certain medical procedure. In yet another example, one or more of the multiple pre-programmed arrangements of visual displays is stored with an identifier indicative of an operator of one or more of the multiple data acquiring sources 125, 130, 135, and 140 to execute the medical procedure.

Upon the user or clinician connecting the multiple data acquiring sources 125, 130, 135, and 140 in communication with the controller 150, the controller 150 is operable to identify the series of data acquiring sources (e.g., CT machine, MRI machine, ultrasound machine, anesthesia machine, etc.) 125, 130, 135, and 140 connected in communication with the controller 150. On one example, the controller 150 can identify each of the series of data acquiring sources 125, 130, 135, and 140 based on the output signal representative of the visual display communicated from the data acquiring source 125, 130, 135, or 140. For example, upon identifying the series of data acquiring sources, the controller 150 can be programmed to automatically identify one of the pre-programmed arrangements of visual displays in the multiple display fields 155, 160, 165, and 170 of the monitor 145 that is associated with the identified series of data acquiring sources 125, 130, 135, and 140. In another example, the user or clinician can also enter an identifier of one of the series of pre-programmed arrangements of visual displays via the input 185. In yet another example, the controller 150 can be pre-programmed to automatically identify one of the pre-programmed arrangements of visual displays in response to an indication of a given procedure or procedure step associated with the selection of the procedure protocol or protocol step.

Upon identifying and recalling from memory 180 one of the pre-programmed arrangements comprising instructions for illustrating the plurality of visual displays, the controller 150 communicates the multiple acquired signals representative of the multiple visual displays to the multiple display fields 155, 160, 165, and 170 for simultaneous viewing or illustration on the at least one monitor 145 in accordance to the instructions of the pre-programmed arrangement. Also, the user can selectively adjust the selected pre-defined arrangement of the visual displays in the multiple display fields 155, 160, 165, and 170 via a subsequent input of another identifier through the input device 185. Yet, there is no need to move a series of switches (e.g., on/off switch, multiple selector switch, etc.), where each switch would associated with one of a series of display fields of a monitor (not shown).

Upon completion of the medical procedure, the controller 150 is operable to receive instructions via the input 185 having another identifier associated with another pre-programmed arrangement of the visual displays in the multiple display fields 155, 160, 165, and 170. For example, the other identifier can be indicative of a new physician or technician employing the already connected multiple image acquiring sources 125, 130, 135, and 140. In another example, one or more of the multiple image acquiring sources 125, 130, 135, and 140 can be disconnected and/or one or more additional imaging acquiring sources can be connected in association with performing a different medical procedure. In yet another example, the controller 150 can be operable to automatically identify and select another of the pre-programmed arrangements based on identification of the re-arranged or additional multiple image acquiring sources 125, 130, 135, and 140 connected or disconnected in communication with the controller 150. In still yet another example, the physician or technician can select another one of the pre-programmed arrangements based on an identifier (e.g., one or more alphanumeric symbols, etc.) representative of a step of another medical procedure.

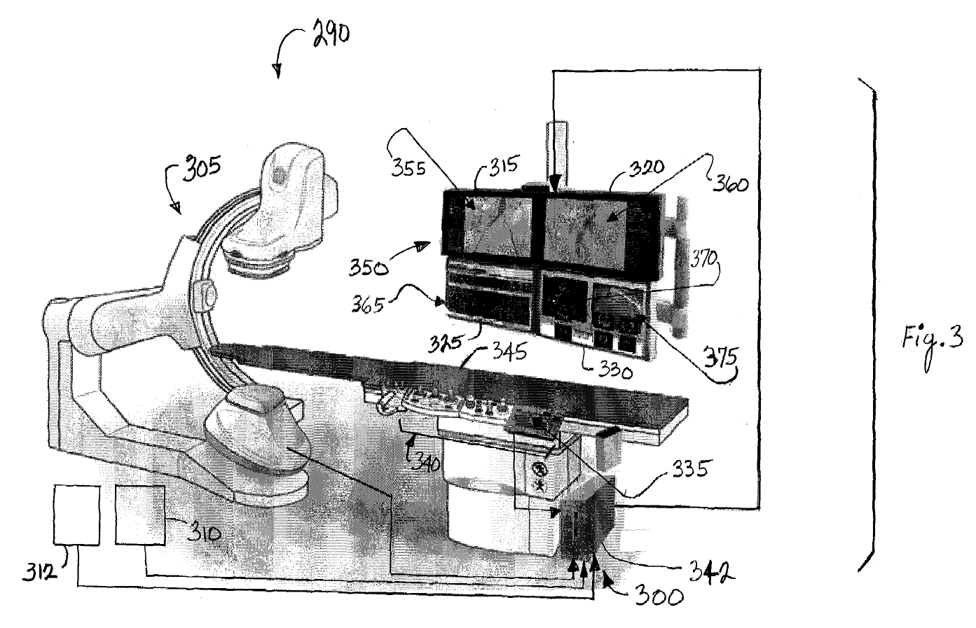

FIG. 3 illustrates an embodiment of a system 290 for performing a medical procedure that includes an embodiment of a mapping control system 300 connected in communication with at least a series of data acquiring sources 305, 310 and 312, and a series of monitors 315, 320, 325, and 330, similar in construction and operation to the mapping system 100 in combination with the data acquiring sources 125, 130, 135, and 140 and at least one monitor 145 as described above in FIG. 1. The exemplary data acquiring source 305 is an X-ray imaging machine, the data acquiring source 310 is an intravascular ultrasound imaging machine, and the data acquiring source 312 is an ECG monitoring machine. The exemplary mapping control system 300 is at least partially incorporated with the data-acquiring source 305. An input device 335 of the mapping control system 300 is incorporated as part of a control station 340 mounted at the tabletop 345 and designated to control operation of the data-acquiring source 305. Via the input device 335, a physician or technician is operable to communicate an input data indicative of a physician identifier and/or a selection of at least one of a series of medical procedure protocols to a controller 342 of the mapping system 300, similar in construction and operation to the controller 150 of the mapping system 100. The controller 342 may be part of the control station 340 or located independently relative thereto. Upon receiving an indication of the physician identifier and/or indication of the at least one medical procedure protocol identifier, the control station 340 initiates set up of the data acquiring source 305 accordingly in a conventional manner. Furthermore, in response to receiving the physician identifier and/or the medical procedure identifier, the controller 342 of the mapping control system 300 automatically identifies and selects one of series of preprogrammed maps, layouts, or arrangements 350 of multiple visual displays 355, 360, 365, 370 and 375 for viewing on the multiple monitors 315, 320, 325 and 330. The exemplary pre-programmed arrangement 350 includes instructions to route a visual display 355 of an X-ray scan image for illustration on at least one display field of the monitor 315, to route a visual display 360 of another X-ray scan image for illustration on at least one display field of monitor 320, to route a visual display 365 of an ECG waveform(s) for illustration on at least one display field of monitor 325, and to route a visual display 370 of an intravascular ultrasound image and a visual display of a stored X-ray image 375 for illustration on at least two display fields, respectively, of the monitor 330.

Although the above description of the mapping systems 100 and 300 is described with reference to performance of a medical procedure, the systems 100 and 300 are not so limited. The systems 100 and 300 can be employed in industrial imaging as well.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for mapping an arrangement of a plurality of visual displays communicated from a plurality of data acquiring sources for illustration on a plurality of displays fields of an at least one monitor, comprising:
a controller in communication with each of the plurality of data acquiring sources, the controller including a processor operable to execute a plurality of programming instructions stored in a memory, the programming instructions including acts of:
receiving at least one predefined arrangement for directing the plurality of visual displays for simultaneous illustration in the plurality of display fields of the at least one monitor;
storing the at least one predefined arrangement in the memory; and
communicating the plurality of visuals displays from the plurality of data acquiring sources for simultaneous illustration in the plurality of display fields, respectively, of the least one monitor in accordance to one of the least one predefined arrangement stored in the memory.

2. The system of claim 1, wherein the acts of receiving and storing is for a plurality of arrangements for directing the plurality of visual displays for simultaneous illustration in the plurality of display fields of at least one monitor, and further comprising the acts of:
receiving an input data including an identifier associated with one of the plurality of arrangements; and
selecting the one of plurality of arrangements associated with the identifier, wherein the act of communicating the plurality of visual displays is in accordance with the one of plurality of arrangements associated with the identifier.

3. The system of claim 2, wherein the identifier is indicative of a step of a medical procedure.

4. The system of claim 2, wherein the identifier is indicative of a physician name.

5. The system of claim 1, wherein the acts of
receiving and storing is of a plurality of arrangements of the plurality of visual displays for simultaneous illustration in the plurality of display fields of the least one monitor via an input device, and further comprising the act of:
receiving and storing an identifier associated with one of the plurality of arrangements in the memory; and
receiving an input data via an input device, the input data indicative of the identifier associated with one of the plurality of arrangements in the memory, wherein the act of communicating the plurality of visual displays for simultaneous illustration in the plurality of display fields is in accordance to the one of the plurality of arrangements associated with the identifier.

6. The system of claim 1, wherein the act of communicating the arrangement of the plurality of visual displays to the plurality of displays fields of the at least one monitor does not include the act of actuating one of a plurality of switches each associated with one of the plurality of display fields of the monitor.

7. The system of claim 1, wherein at least one of the visual displays is continuously acquired and communicated to the controller.

8. The system of claim 1, wherein at least one of the visual displays is previously acquired by one of the data acquiring sources.

9. The system of claim 1, wherein one of the data acquiring sources is an X-ray imaging machine, and wherein the controller and the input device are located at the X-ray imaging machine.

10. A method of communicating a plurality of visual displays for simultaneous viewing on at least one monitor, each visual display received from one of a plurality of data acquiring sources, the method comprising the acts of:
receiving a plurality of predefined arrangements of the plurality of visual displays for simultaneous illustration in the plurality of display fields of the at least one monitor and storing the plurality of arrangements in a memory; and
communicating the plurality of visuals displays from the plurality of data acquiring sources to the plurality of display fields, respectively, of the least one monitor in accordance to one of the plurality of predefined arrangements stored in the memory.

11. The method of claim 10, wherein the acts of
receiving and storing is of a plurality of arrangements of the plurality of visual displays for simultaneous illustration in the plurality of display fields of the least one monitor via an input device, and further comprising the act of:
receiving and storing an identifier with associated with one of the plurality of arrangements in the memory; and
receiving an input data via an input device, the input data indicative of the identifier associated with one of the plurality of arrangements in the memory, wherein the act of communicating the plurality of visual displays for simultaneous illustration in the plurality of display fields is in accordance to the one of the plurality of arrangements associated with the identifier.

12. The method of claim 11, wherein the identifier is indicative of a step of a medical procedure.

13. The method of claim 11, wherein the identifier is indicative of a physician name.

14. The method of claim 10, wherein the method does not include the act of actuating one of a plurality of switches each associated with one of the plurality of display fields of the monitor.

15. The method of claim 10, wherein at least one of the visual displays is continuously acquired and communicated to the controller.

16. The method of claim 10, wherein at least one of the visual displays is previously acquired by one of the data acquiring sources.

17. The method of claim 10, wherein one of the data acquiring sources is an X-ray imaging machine, and further comprising the act of receiving an identifier indicative of one of the plurality of arrangements via an input device at the X-ray imaging machine.

18. A system for illustrating a plurality of visual displays received from a plurality of data acquiring sources, comprising:
at least one monitor comprising a plurality of display fields;
an input device;
a controller connected in communication with the at least one monitor, each of the plurality of data acquiring sources and the input device, the controller including a processor operable to execute a plurality of programming instructions stored in a memory, the programming instructions including acts of:
receiving a plurality of arrangements for directing the plurality of visual displays for simultaneous illustration on the plurality of display fields of the at least one monitor;
receiving the plurality of the visual displays from the plurality of data acquiring sources;
automatically selecting one of the plurality of arrangements in response to receiving an identifier indicative of the one of the plurality of arrangements via the input device; and
illustrating the plurality of visual displays in the plurality of display fields simultaneously on the at least one monitor in accordance to the identifier.

19. The system of claim 18, wherein one of the data acquiring sources is an X-ray imaging machine, and wherein the controller and the input device are located at the X-ray imaging machine.

20. The system of claim 18, wherein the identifier is indicative of one of a medical procedure and a physician name.
